(19) United States
(12) Patent Application Publication
(10) Pub. No.: US 2018/0131920 A1
(43) Pub. Date: May 10, 2018

(54) DISPLAY APPARATUS AND CONTROL METHOD THEREOF

(71) Applicant: SAMSUNG ELECTRONICS CO., LTD., Suwon-si (KR)

(72) Inventors: Dae-wang KIM, Suwon-si (KR); Han-byoul JEON, Yongin-si (KR); Jeong-hun PARK, Seongnam-si (KR)

(21) Appl. No.: 15/796,956

(22) Filed: Oct. 30, 2017

(30) Foreign Application Priority Data
Nov. 8, 2016 (KR) 10-2016-0148222

(51) Int. Cl. H04N 13/00

(52) U.S. Cl. CPC H04N 13/0011; H04N 13/004; H04N 13/0029; H04N 13/0059

(57) ABSTRACT

Disclosed is a display apparatus comprising: a communicator comprising communication circuitry configured to communicate with a server capable of providing content divided into segments and having a plurality of resolutions; a video processor configured to perform a video process with regard to the content; a display configured to display an image of the processed content; and a controller configured to control the display apparatus to receive a segment of the content having a first resolution from the server, to display an area of a stereoscopic image on the display based on the received segment, to transmit information about an area more likely to be displayed within the stereoscopic image to the server, to receive a segment corresponding to the area more likely to be displayed and having a second resolution higher than the first resolution from the server, and to display the stereoscopic image based on the received segment having the second resolution.

### CROSS-REFERENCE TO RELATED APPLICATION

This application is based on and claims priority under 35 U.S.C. § 119 to Korean Patent Application No. 10-2016-0148222 filed on Nov. 8, 2016 in the Korean Intellectual Property Office, the disclosure of which is incorporated by reference herein in its entirety.

### BACKGROUND

### Field

The present disclosure relates generally to a display apparatus and a control method thereof, and for example, to a display apparatus for receiving a content image and a control method thereof.

### Description of Related Art

An extended video refers to an image obtained by stitching images taken by many lenses together. As an example of the extended video, there is a 360-degree image. In this case, two or more lenses are used to take images in all directions of 360 degrees without any discontinuity. Such a 360-degree image allows a user to view all the left, right, up, down, front and rear areas of the image through a virtual reality (VR) device or the like.

With recent development of imaging technology, the extended video has been gradually universalized but required a much higher bandwidth than a general image in order to provide a high-quality image to a user. However, it is difficult to continuously provide a high-quality extended video since viewing devices of users vary in network state.

Further, a user wants to view a vivid and realistic extended video even if the extended video has a limited network bandwidth.

### SUMMARY

Accordingly, an aspect of one or more example embodiments may provide a display apparatus for continuously providing a high-quality extended video to a user who is viewing the extended video, and a control method thereof.

Further, another aspect of one or more example embodiments may provide a display apparatus for providing a vivid and realistic extended video to a user who is viewing the extended video within a restricted network state, and a control method thereof.

According to an example embodiment, a display apparatus is provided, the display apparatus comprising: a communicator comprising communication circuitry configured to communicate with a server capable of providing content divided into segments and having a plurality of resolutions; a video processor configured to perform a video process on the content; a display configured to display an image of the processed content; and a controller configured to control the display apparatus to receive a segment of the content having a first resolution from the server, to display an area of a stereoscopic image on the display based on the received segment, to transmit information about an area more likely to be displayed within the stereoscopic image to the server, to receive a segment corresponding to the area more likely to be displayed and having a second resolution higher than the first resolution from the server, and to display the stereoscopic image based on the received segment having the second resolution.

According to an example embodiment, it is possible to continuously provide a high-quality extended video to a user when the user views an extended video (e.g. a 360-degree image).

The information may comprise at least one of information about a user's current line of sight, information about movement in users' sight lines according to timeslots, and information about a user's gesture and voice.

The server may determine an area more likely to be displayed within the stereoscopic image based on at least one of information received from the display apparatus, content production information involved in the content, and advertisement information. Thus, it is possible to make an area of the extended video more likely to be displayed on a screen be streamed with a high resolution by taking many pieces of information for predicting movement of a user's line of sight into account.

The controller may control the display apparatus to transmit information about a network state of the display apparatus to the server, and may determine a highest resolution of an image of a segment received from the server based on the network state. Thus, it is possible to stream the extended video with an optimum and/or improved resolution by taking a network state of a user's viewing device into account.

The controller may receive a segment, which does not correspond to the area more likely to be displayed and is processed to have a third resolution lower than the first resolution, from the server. Thus, a part of the extended video more likely to be displayed on the screen as a user's line of sight moves is processed to have a higher resolution than the other parts, and it is therefore possible to provide an image with higher quality even under a restricted network state.

The controller may control the video processor to stitch together a first segment corresponding to the area more likely to be displayed and a second segment not corresponding to the area more likely to be displayed, which are received from the server. Thus, the segments received with different resolutions may be stitched together and reproduced as one frame.

The controller may control the display apparatus to preferentially receive a first segment corresponding to the area more likely to be displayed, and to receive a second segment not corresponding to the area more likely to be displayed, from the server. Thus, a part of the extended video more likely to be displayed on the screen is preferentially streamed, and a part less likely to be displayed on the screen is then streamed, thereby providing an image with higher quality even under a restricted network state.

The controller may control the display apparatus to periodically transmit information about the area more likely to be displayed to the server. Thus, the latest information for predicting the movement in a user's line of sight is reflected in streaming a part of the extended video more likely to be displayed on a screen.

The controller may control the display apparatus to transmit information about the user's current line of sight to the server if the user's current line of sight is maintained for a predetermined period of time or more. Thus, a state where a user's current line of sight is maintained for a predetermined period of time or more is reflected as meaningful information in determining a part of the extended video more likely to be displayed on the screen.

The server may store the segments divided from the content and processed according to a plurality of resolutions. Thus, it is possible to stream a segment having a high resolution previously stored corresponding to the area of the extended video more likely to be displayed on the screen.

According to an example embodiment, a method of controlling a display apparatus is provided, the method comprising: communicating with a server capable of providing content divided into segments and having a plurality of resolutions; receiving a segment of the content having a first resolution from the server, and displaying an area of a stereoscopic image on the display based on the received segment; transmitting information about an area more likely to be displayed within the stereoscopic image to the server; receiving a segment corresponding to the area more likely to be displayed and having a second resolution higher than the first resolution from the server; and displaying the stereoscopic image based on the received segment having the second resolution.

According to an example embodiment, it is possible to continuously provide a high-quality extended video to a user when the user views an extended video (e.g. a 360-degree image).

The information may comprise at least one of information about a user's current line of sight, information about movement in users' sight lines according to timeslots, and information about a user's gesture and voice.

The server may determine an area more likely to be displayed within the stereoscopic image based on at least one of information received from the display apparatus, content production information involved in the content, and advertisement information. Thus, it is possible to make an area of the extended video more likely to be displayed on a screen be streamed with a high resolution by taking many pieces of information for predicting movement of a user's line of sight into account.

The method may further comprise: transmitting information about a network state of the display apparatus to the server; and determining a highest resolution of an image of a segment received from the server based on the network state. Thus, it is possible to stream the extended video with an optimum and/or improved resolution by taking a network state of a user's viewing device into account.

The method may further comprise: receiving a segment, which does not correspond to the area more likely to be displayed and is processed to have a third resolution lower than the first resolution, from the server. Thus, a part of the extended video more likely to be displayed on the screen as a user's line of sight moves is processed to have a higher resolution than the other parts, and it is therefore possible to provide an image with higher quality even under a restricted network state.

The method may further comprise: stitching a first segment corresponding to the area more likely to be displayed and a second segment not corresponding to the area more likely to be displayed, which are received from the server. Thus, the segments received with different resolutions are stitched together and reproduced as one frame.

The method may further comprise: preferentially receiving a first segment corresponding to the area more likely to be displayed from the server; and then receiving a second segment not corresponding to the area more likely to be displayed from the server. Thus, a part of the extended video more likely to be displayed on the screen is preferentially streamed, and a part less likely to be displayed on the screen is then streamed, thereby providing an image with higher quality even under a restricted network state.

The method may further comprise periodically transmitting information about the area more likely to be displayed to the server. Thus, the latest information for predicting the movement in a user's line of sight is reflected in streaming a part of the extended video more likely to be displayed on a screen.

The method may further comprise transmitting information about the user's current line of sight to the server if the user's current line of sight is maintained for a predetermined period of time or more. Thus, a state where a user's current line of sight is maintained for a predetermined period of time or more is reflected as meaningful information in determining a part of the extended video more likely to be displayed on the screen.

The method may further comprise, storing, by the server, the segments divided from the content and processed according to a plurality of resolutions. Thus, it is possible to stream a segment having a high resolution previously stored corresponding to the area of the extended video more likely to be displayed on the screen.

### BRIEF DESCRIPTION OF THE DRAWINGS

The above and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a block diagram illustrating an example display apparatus according to an example embodiment;

FIG. 2 is a diagram illustrating an example of a virtual interface to be provided to a user according to an example embodiment;

FIG. 3 is a diagram illustrating an example of a method of creating an extended video according to an example embodiment;

FIG. 4 is a diagram illustrating an example of an extended video displayed on a screen as a user's line of sight moves according to an example embodiment;

FIG. 5 is a diagram illustrating an example of streaming an extended video from a server to the display apparatus according to an example embodiment;

FIG. 6 is a block diagram illustrating example elements for streaming an extended video from a server to the display apparatus according to an example embodiment; and

FIG. 7 is a flowchart illustrating an example method of controlling the display apparatus according to an example embodiment.

### DETAILED DESCRIPTION

Hereinafter, various example embodiments will be described in greater detail with reference to accompanying drawings. The present disclosure may be achieved in various forms and not limited to the following embodiments. For clear description, like numerals refer to like elements throughout.

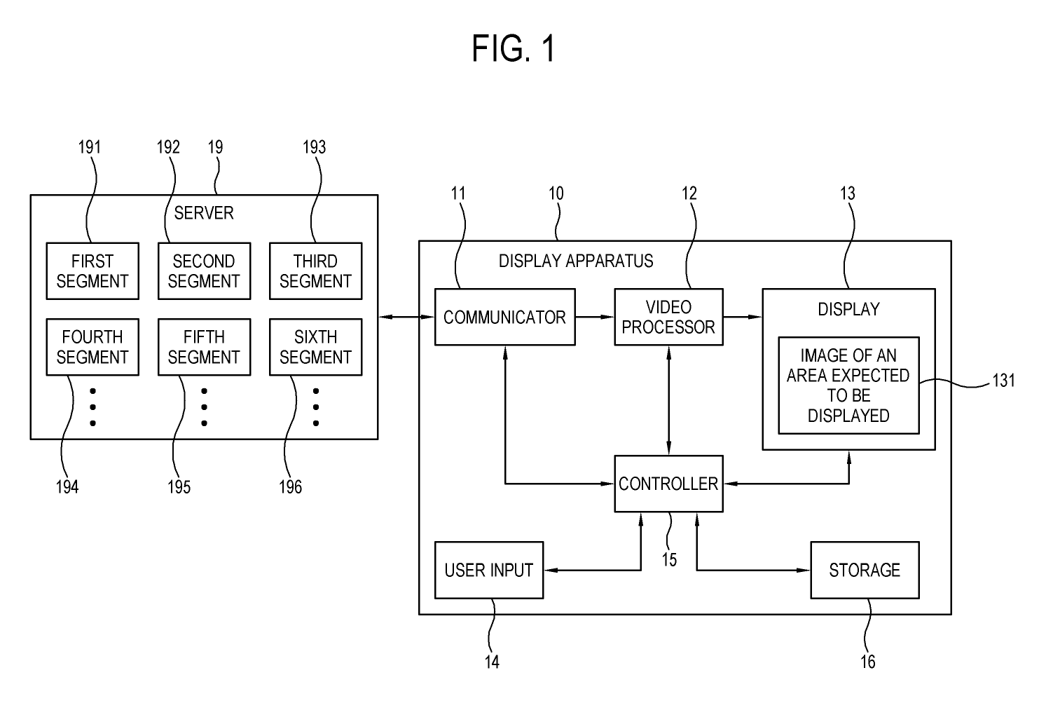

Below, features and embodiments of a display apparatus 10 will be first described with reference to FIG. 1 to FIG. 6. FIG. 1 is a block diagram illustrating an example display apparatus according to an example embodiment. As illustrated in FIG. 1, a display apparatus 10 according to an example embodiment includes a communicator (e.g., including communication circuitry) 11, a video processor (e.g., including video processing circuitry) 12, a display 13, a user input (e.g., including input circuitry) 14, a controller (e.g., including processing circuitry) 15 and a storage 16. For example, and without limitation, the display apparatus 10 may be achieved by a virtual reality (VR) device, a television (TV), a smart phone, a tablet personal computer, a computer, or the like. According to an example embodiment, the display apparatus 10 may connect with a server 19 through the communicator 11 and receive a video signal of content from the server 19. The elements of the display apparatus 10 are not limited to the foregoing descriptions, and may exclude some elements or include some additional elements.

According to an example embodiment, the display apparatus 10 may receive an image of at least one segment, which includes an area 131 expected to be displayed within an image of content more likely to be displayed on the display 13, from among images 191, 192, 193, 194, 195, 196, . . . of a plurality of segments divided from the image of the content.

Further, the display apparatus 10 according to an example embodiment processes the image of at least one segment, which includes the area 131 expected to be displayed in the image of content more likely to be displayed on the display 13, among the images 191, 192, 193, 194, 195, 196, . . . of the plurality of segments divided from the image of the content.

The server 19 may be realized by a content provider that stores an image of content produced by a content producer, and provides the image of content in response to a request of the display apparatus 10. Here, the image of content may, for example, be an extended video, e.g. a 360-degree image viewable in all directions. The extended video may be created by stitching two or more images, which are respectively taken by two or more lenses, together. According to an example embodiment, the extended video may include weight information set by the content producer according to areas and timeslots, and a resolution to be applied according to the areas and the timeslots may be determined based on the set weight information.

The server 19 may store a plurality of images corresponding to plural pieces of content, and stores images 191, 192, 193, 194, 195, 196 . . . corresponding to a plurality of segments divided from the image of each piece of content in accordance with a plurality of resolutions. For example, if the 360-degree image is stored in the server 19, the 360-degree image may be divided into the plurality of segments corresponding to upper left, upper right, upper front, upper rear, lower left, lower right, lower front and lower rear areas in consideration of all of up, down, left, right, front and rear directions. At this time, the server 19 may store a plurality of images different in resolution with respect to respective divided segments. For example, images corresponding to resolutions of 1280*720(720p), 1920*1080(1080p) and 3840*2160(4K) may be stored with respect to the segment corresponding to the upper left area among the plurality of segments divided from the 360-degree image. Likewise, images corresponding to different resolutions may be stored with regard to the other segments.

The communicator 11 may include various communication circuitry and communicates with the server 19, which is storing the images corresponding to the plurality of pieces of content, by, for example, a wire or wirelessly, and receives the image of content from the server 19. Further, the communicator 11 sends the server 19 information about a network state, a user's current line of sight, a user's gesture and voice, etc. collected in the display apparatus 10. To communicate with the server 19, the communicator 11 may use a wired communication method such as Ethernet, etc. or a wireless communication method Wi-Fi, Bluetooth, etc. through a wireless router. For example, the communicator 11 may include various communication circuitry, such as, for example, and without limitation, a printed circuit board (PCB) including a wireless communication module for Wi-Fi. However, there are no limits to the communication methods of the communicator 11. Alternatively, the communicator 11 may communicate with the server 19 through another communication method.

The video processor 12 may include various video processing circuitry and may perform a preset video processing process with regard to a video signal of content received from the server 19 through the communicator 11. According to an example embodiment, if the image of at least one segment, which includes the area 131 expected to be displayed in the image of content more likely to be displayed on the display 13, is received among the images 191, 192, 193, 194, 195, 196, . . . of the plurality of segments divided from the image of the content, the video processor 12 may perform the video processing process to stitch frames corresponding to the received image of at least one segment together into one frame.

As an example of the video processing process performed by the various video processing circuitry in the video processor 12, includes, but is not limited to, de-multiplexing, decoding, de-interlacing, scaling, noise reduction, detail enhancement, or the like, without limitations. The video processor 12 may be realized as a system on chip (SoC) where many functions are integrated, or an image processing board where individual modules for independently performing respective processes are mounted.

The display 13 displays an image of content based on a video signal processed by the video processor 12. According to an example embodiment, the display 13 displays some areas of the image of content based on a user's input. For example, the display 13 displays the image of at least one segment, which includes the area 131 expected to be displayed in the image of content more likely to be displayed on the display 13, among the images 191, 192, 193, 194, 195, 196, . . . of the plurality of segments divided from the image of the content.

The display 13 may be achieved by various types. For example, the display 13 may be achieved by a plasma display panel (PDP), a liquid crystal display (LCD), an organic light emitting diode (OLED), a flexible display, or the like, but is not limited thereto.

The user input 14 may include various input circuitry and receives a user's input for controlling at least one function of the display apparatus 10. According to an example embodiment, the user input 14 receives a user's input for displaying some areas of the image of content on the display 13.

The user input 14 may include various input circuitry, such as, for example, and without limitation, a remote controller that uses infrared to communicate with the display apparatus 10 and includes a plurality of buttons a keyboard, a mouse, a touch screen provided on the display apparatus 10, an input panel provided on an outer side of the display apparatus 10, an iris recognition sensor or a gyro sensor for sensing movement of a user's line of sight based on movement of an iris or a neck, a voice recognition sensor for sensing a user's voice, a motion recognition sensor for sensing a user's gesture, or the like.

The storage 16 may store the images corresponding to the plurality of pieces of content reproducible in the display apparatus 10. The storage 16 may store an image of content received from the server 19 through the communicator 11, or store an image of content received from a universal serial bus (USB) memory stick or the like device directly connected to the display apparatus 10. The storage 16 performs reading, writing, editing, deleting, updating, etc. with regard to data about the stored content image. The storage 16 may include, for example, and without limitation, a flash memory stick, a hard-disc drive or the like nonvolatile memory stick so as to retain data regardless of whether the display apparatus 10 is powered on or off.

The controller 15 may include various processing circuitry, such as, for example, and without limitation, at least one processor for controlling a program command to be executed so that all the elements involved in the display apparatus 10 can operate. The at least one processor may include a central processing unit (CPU), and may, for example, include three regions for control, a computation and a register. The control region analyzes a program command, and controls the elements of the display apparatus 10 to operate in accordance with the analyzed commands. The computation region performs arithmetic operations and logical operations, and implements computations needed for operating the elements of the display apparatus 10 in response to a command from the control region. The register region may be a memory location to store information or the like needed while the CPU is executing an instruction, stores instructions and data for the elements of the display apparatus 10 and computation results.

The controller 15 may receive an image of at least one segment, which includes an area 131 expected to be displayed within an image of content more likely to be displayed on the display 13, among images 191, 192, 193, 194, 195, 196, . . . of a plurality of segments divided from the image of the content. The controller 15 controls the image of the received segment to be processed and displayed on the display 13.

Here, the area expected to be displayed may be determined based on at least one of a user's current line of sight, information about movement of users' sight lines according to timeslots, information about production of content, advertisement information, and information about a user's gesture and voice.

According to an example embodiment, the controller 15 may stream from the server 19 an image of a segment including a part of a content image corresponding to a user's current line of sight. Thus, an area of a content image, on which a user's current line of sight stays, is seen with higher quality when s/he views the content image.

If a user's current line of sight stays (e.g., is maintained) for a predetermined period of time or more, the controller 15 may transmit information about the user's current line of sight to the server 19 and controls a part of the content image corresponding to the current sight line to have high quality when this part is selected again by a user. For example, if an angle of view selected by a user to view a content image is maintained for a predetermined period of time, the display apparatus 10 transmits information about the selected angle of view to the server 19. Thus, it is possible to stream a high-quality image with regard to a meaningful angle of view selected by a user.

According to an example embodiment, the controller 15 may stream from the server 19 an image of a segment corresponding to an area more likely to be displayed on the display 13, based on information about movement of a user's line of sight according to timeslots among pieces of information about users' histories of previously viewing an image of content.

The server 19 may generate information about a recommended angle of view according to timeslots with respect to a content image, based on information about movement of users' sight lines according to timeslots. At this time, the server 19 may adjust a resolution of a content image to be streamed according to angles of view, based on the generated information about the recommended angle of view according to timeslots.

Thus, information about movement of former viewers' lines of sight according to timeslots may be taken into account when a content image is displayed, and it is therefore possible to control an area of the content image more likely to be displayed by a current viewer to be displayed with higher quality.

According to an example embodiment, the controller 15 may stream from the server 19 an image of a segment corresponding to weight information about areas and timeslots given by a content producer with regard to the image of content. Thus, an area of a content image corresponding to an area and timeslot intended by a content producer may be displayed with higher quality when a user views the content image.

According to an example embodiment, the controller 15 may stream from the server 19 an image of a segment included in an area and timeslot relevant to advertisement content inserted in the image of content. Thus, advertisement included in an image of content may be displayed with higher quality when a user views the content image.

According to an example embodiment, the controller 15 may stream from the server 19 an image of a segment corresponding to an area more likely to be displayed on the display 13, based on a user's voice or gesture. Thus, an area of a content image displayed in response to a user's voice or gesture may be displayed with higher quality when a user views the content image.

The controller 15 may control an image of at least one segment including an area 131 expected to be displayed to have a high resolution and be preferentially received. For example, an area of a content image, on which a user's current line of sight stays for a predetermined period of time or more, may be displayed with a higher resolution when s/he views the content image.

The controller 15 may receive an image of at least one first segment corresponding to an area 131 expected to be displayed among images 191, 192, 193, 194, 195, 196, . . . of a plurality of segments, and then receive an image of at least one second segment not corresponding to the area 131 expected to be displayed. For example, information about movement of former viewers' lines of sight according to timeslots is taken into account when a content image is displayed, and an image of a segment corresponding to an area more likely to be displayed by movement of a current viewer's line of sight may be preferentially received, thereby providing a high-quality image even under a restricted network state.

The controller 15 may stream from the server 19 an image of at least one segment including an area 131 expected to be displayed. Here, the controller 15 may transmit information about a network state of the display apparatus 10 to the server 19, and determine a highest resolution of an image of at least one segment to be streamed from the server 19 based on the information about the network state. Thus, an image of the area 131 highly expected to be displayed on the display 13 is continuously given with high quality from the server 19. Further, the network state of the display apparatus 10 is taken into account to thereby provide an image having an optimum and/or improved resolution.

According to another example embodiment, the controller 15 may control an image of at least one segment, which includes an area 131 expected to be displayed within an image of content more likely to be displayed on the display 13, among images 191, 192, 193, 194, 195, 196, . . . of a plurality of segments divided from the image of the content to be processed with high quality.

Here, the area 131 expected to be displayed may be determined based on at least one of a user's current line of sight, information about movement of users' sight lines according to timeslots, information about production of content, advertisement information, and information about a user's gesture and voice, or the like, but is not limited thereto. Thus, an area of a content image to be displayed is determined by considering many pieces of information for predicting movement of a user's line of sight and processed with higher quality.

The controller 15 may process an image of at least one segment, which includes an area 131 expected to be displayed, to have a high resolution. Thus, a part of a content image more likely to be displayed according to movement of a user's sight line can have high quality.

The controller 15 processes the image of the at least one first segment corresponding to the area 131 expected to be displayed among images 191, 192, 193, 194, 195, 196, . . . of a plurality of segments to have a first resolution, and processes the image of the at least one second segment not corresponding to the area 131 expected to be displayed to have a second resolution lower than the first resolution.

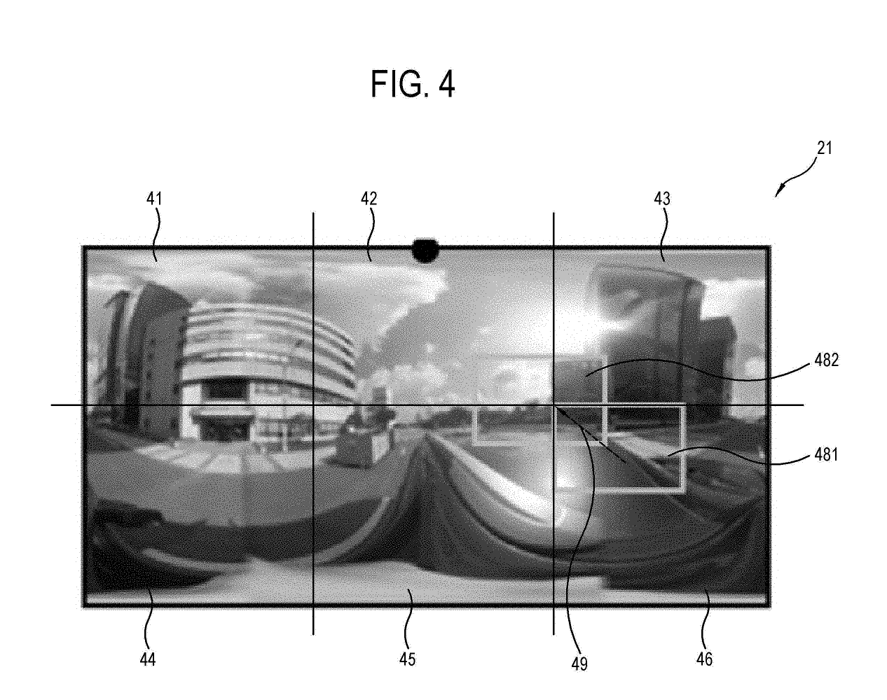

The controller 15 may stream from the server 19 a high-resolution image of at least one segment including an area 131 expected to be displayed. For example, as illustrated in FIG. 4, if a user's line of sight 49 moves from a first area 481 expected to be displayed in an extended video 21 displayed on the display 13 to a second area 482 expected to be displayed, images 42, 43, 45 and 46 of four segments including the second area 482 expected to be displayed are streamed to have a high resolution among images 41, 42, 43, 44, 45 and 46 of a plurality of segments divided from the extended video 21. At this time, images 41 and 44 of segments excluding the second area 482 expected to be displayed among the images 41, 42, 43, 44, 45 and 46 of the plurality of segments are streamed to have a resolution lower than that of the images 42, 43, 45 and 46 of four segments.

According to this example embodiment, a part of a content image more likely to be displayed as a user's line of sight moves is streamed to have a higher resolution than the other parts, thereby providing a vivid image to a user under a restricted network state.

The controller 15 may transmit information about the network state of the display apparatus 10 to the server 19, and determine a highest resolution of an image of at least one segment to be streamed from the server 19 based on the network state. Thus, it is possible to provide a content image having an optimum resolution to a user in consideration of the network state of the display apparatus 10.

As described above, the display apparatus 10 according to an example embodiment may continuously provide a high-quality extended video to a user when s/he views the extended video. Further, it is possible to provide a vivid and realistic extended video to a user even under a restricted network state.

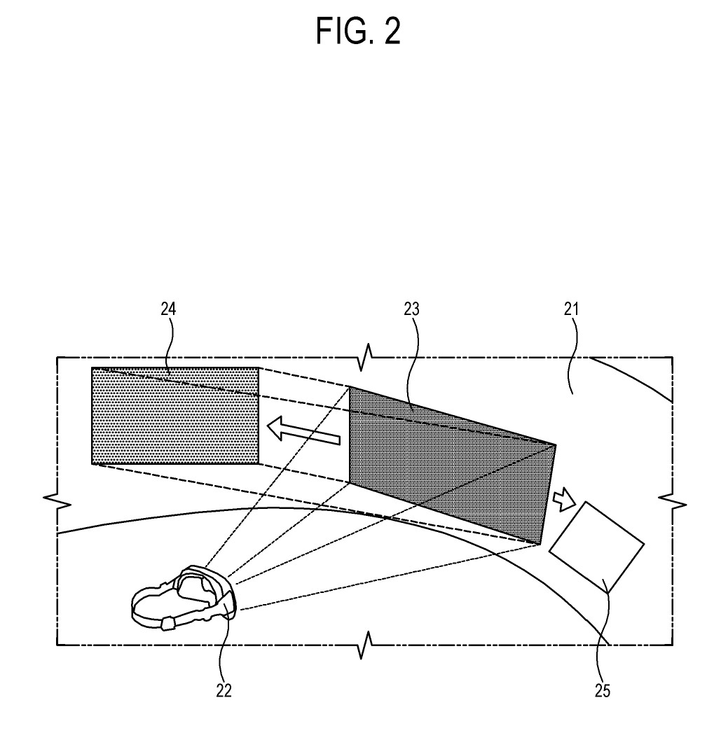

FIG. 2 is a diagram illustrating an example of a virtual interface of an extended video provided to a user according to an example embodiment. As illustrated in FIG. 2, if a user views the extended video 21 through a VR device 22, a part of the extended video 21, e.g., an image 23 of a first area expected to be displayed is displayed on a screen of the VR device 22 in accordance with a user's current line of sight. At this time, an area including the image 23 of the first area expected to be displayed within the extended video 21 is streamed to have a high resolution, thereby providing a high-quality image to a user.

According to an example embodiment, an image 24 of a second area expected to be displayed may be determined as an image more likely to be displayed on the screen of the VR device 22, based on information about movement of users' sight line according to timeslots of information about view history of users who have viewed the extended video 21. In this case, the area including the image 24 of the second area expected to be displayed within the extended video 21 may be preferentially streamed. Further, the area including the image 24 of the second area expected to be displayed may be streamed to have a high resolution.

According to another example embodiment, an image 25 of a third area expected to be displayed may be determined as an image more likely to be displayed on the screen of the VR device 22, based on information about an area and timeslot which involves advertisement content inserted in the extended video 21. In this case, an area of the extended video 21, which includes the image 25 of the third area expected to be displayed, may be preferentially streamed. Further, the area including the image 25 of the third area expected to be displayed may be streamed to have a high resolution.

As mentioned above, according to an example embodiment, many pieces of information for predicting movement of a user's line of sight, such as information about a user's current line of sight, information about view history of former users, information about advertisement, or the like, may be taken into account when a user views the extended video 21, so that a part of the extended video 21, which is more likely to be displayed on the screen, can be displayed with high quality.

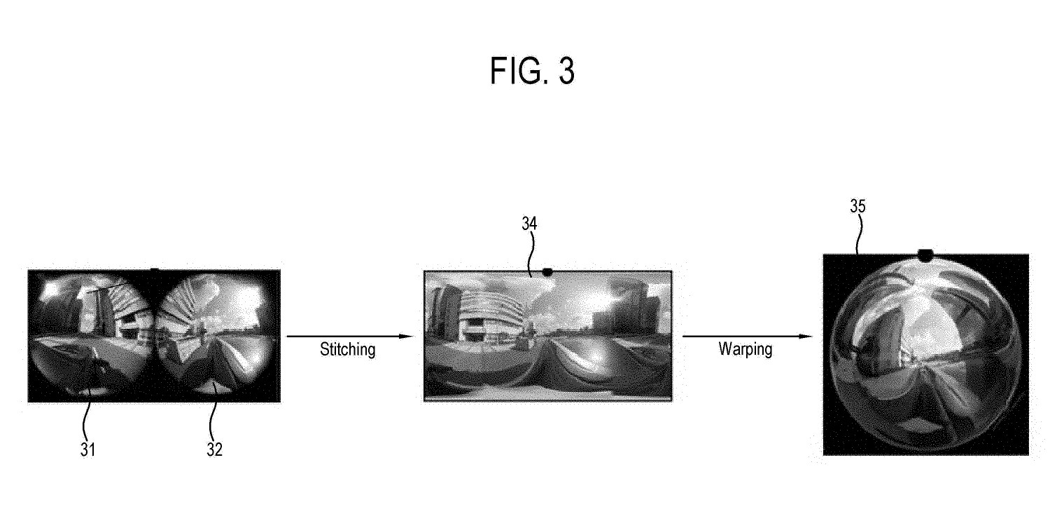

FIG. 3 is a diagram illustrating an example of a method of creating an extended video according to an example embodiment. As illustrated in FIG. 3, to create a 360-degree image as an example of the extended video, many cameras are used to photograph a plurality of images corresponding to all directions. For example, a first lens and a second lens, each of which has an angle of view of 180 degrees, are used to photograph a first angle image 31 and a second angle image 32, respectively.

The first angle image 31 and the second angle image 32 may be stitched together and mapped to a sphere, and then mapped to an equirectangular flat image 34 so as to be compatible between different apparatuses. At this time, the equirectangular flat image 34 may, for example, be created as if a globe is turned into a flat map.

A spherical stereoscopic image 35 is generated by warping and mapping the equirectangular flat image 34 into a sphere, so that a user can view the equirectangular flat image 34 through the display apparatus 10. At this time, an area selected by a user within the spherical stereoscopic image 35 may be cropped and zoomed in and out, and the cropped image may be adjusted in quality and then displayed on the screen.

As described above, according to an example embodiment, a plurality of omnidirectional images taken by a plurality of lenses are stitched together to create an extended video such as a 360-degree image.

FIG. 4 is a diagram illustrating an example of an extended video displayed on a screen as a user's line of sight moves according to an example embodiment. As illustrated in FIG. 4, the extended video 21 may be divided into images 41, 42, 43, 44, 45 and 46 corresponding to a plurality of segments and stored in the server 19. At this time, the images 41, 42, 43, 44, 45 and 46 corresponding to the plurality of segments may be stored according to a plurality of different resolutions.

According to an example embodiment, an image 46 corresponding to a sixth segment is streamed to have a high resolution since the image 46 includes the first area 481 expected to be displayed within the extended video 21, on which a user's line of sight is maintained for a predetermined period of time or more, among the images 41, 42, 43, 44, 45 and 46 of the plurality of segments.

According to an example embodiment, suppose that a user's line of sight 49 moves from the first area 481 expected to be displayed within the extended video 21 displayed on the display 13 to the second area 482 expected to be displayed. At this time, the movement in a user's line of sight 49 from the first area 481 expected to be displayed to the second area 482 expected to be displayed may be predicted based on at least one of information about movement of former users' lines of sight according to timeslots, information about production of content, advertisement information, and information about a user's gesture and voice, or the like.

If the movement to the second area 482 expected to be displayed is predicted, the images 42, 43, 45 and 46 of four segments, which involve the second area 482 expected to be displayed, are preferentially received among the images 41, 42, 43, 44, 45 and 46 of the plurality of segments. At this time, the images 42, 43, 45 and 46 of four segments including the second area 482 expected to be displayed are streamed to have a high resolution, but the images 41 and 44 of the segments excluding the second area 482 expected to be displayed are streamed to have a resolution lower than the resolution of the images 42, 43, 45 and 46 of the four segments.

Since a part of a content image more likely to be displayed is streamed to have a higher resolution than other parts as a user's line of sight moves, it is possible to provide a vivid image to a user even under a restricted network state.

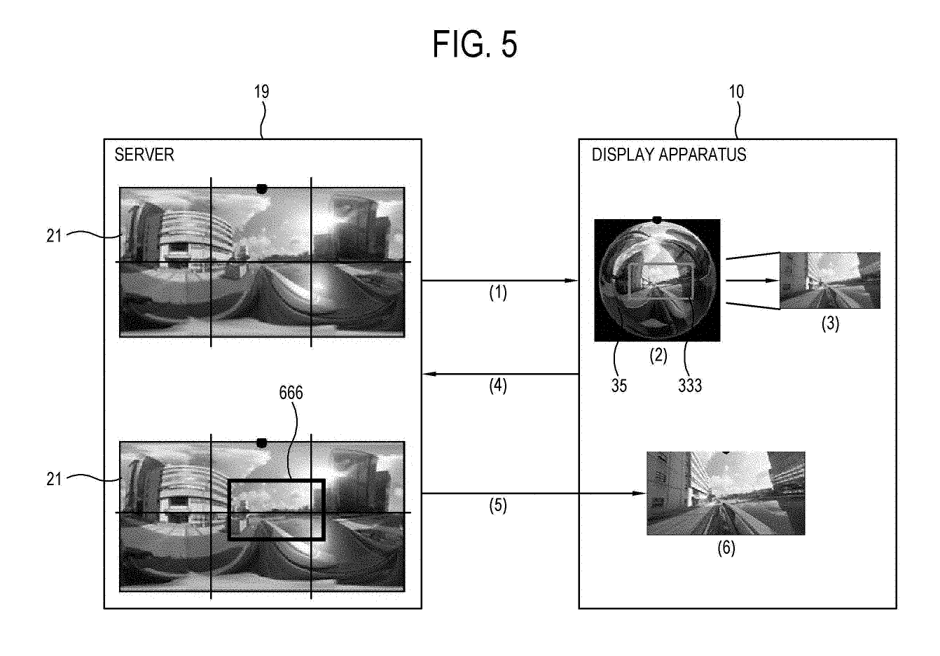

FIG. 5 is a diagram illustrating an example of streaming an extended video from a server to the display apparatus according to an example embodiment. As illustrated in FIG. 5, the server 19 divides and stores an image of content produced by a content producer into a plurality of segments. At this time, the image of content may be given as an extended video (e.g. a 360-degree image) created by stitching a plurality of images omni-directionally taken by many cameras. The server 19 maps such a created extended video 21 to an equirectangular flat image, and then divides and stores it into a plurality of segments.

When dividing and storing the extended video 21 into the plurality of segments, the server 19 may process and store each segment according to a plurality of resolutions.

Referring to (1) of FIG. 5, the display apparatus 10 receives images of a plurality of segments, which are divided from the extended video 21, from the server 19 in response to a user's play request. At this time, the received images corresponding to the plurality of segments have a first resolution.

Referring to (2) of FIG. 5, the display apparatus 10 creates a stereoscopic image 35 by stitching together the received images corresponding to the plurality of segments and having the first resolution. For example, if an image of content stored in the server 19 is a 360-degree image, the display apparatus 10 creates a spherical stereoscopic image 35.

Referring to (3) of FIG. 5, a part 333 of the spherical stereoscopic image 35 is displayed on a screen in response to a user's selection. At this time, the part 333 of the spherical stereoscopic image 35 is displayed with the first resolution corresponding to the plurality of received segments.

Referring to (4) of FIG. 5, the display apparatus 10 transmits information for determining an area more likely to be displayed on the screen to the server 19. The information includes at least one of a user's current line of sight, information about movement of users' sight lines according to timeslots, information about production of content, advertisement information, and information about a user's gesture and voice, or the like. For example, if a user's current line of sight is maintained for a predetermined period of time or more, information about the user's current line of sight is transmitted to the server 19 in order to determine an area to be streamed. Alternatively, information about movement in sight lines of users, who have played the extended video 21, according to timeslots is transmitted to the server 19, thereby determining an area to be streamed. However, information to be transmitted to the server 19 is not limited to those of the foregoing example embodiment, and may additionally include information needed for determining an area more likely to be displayed by a user on a screen among all the areas of the extended video 21.

Referring to (5) of FIG. 5, the display apparatus 10 receives at least one segment corresponding to an area 666 more likely to be displayed, which is determined based on the information and processed to have a second resolution higher than the first resolution, from the server 19.

Referring to (6) of FIG. 5, the display apparatus displays an area, which corresponds to at least one received segment having the second resolution within the spherical stereoscopic image 35, on the screen.

According to the foregoing example embodiment, the display apparatus 10 may more vividly provide a part of the 360-degree image more likely to be displayed on the screen, based on information about a user's line of sight or information about movement of former users' sight line, or the like, while a user views a 360-degree image.

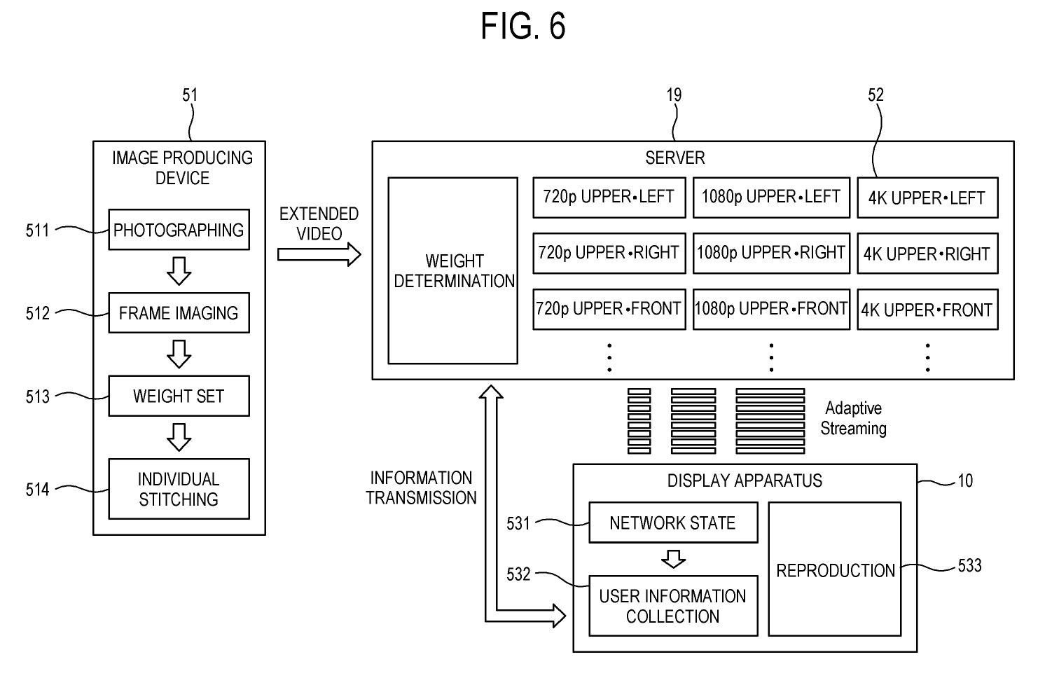

FIG. 6 is a block diagram illustrating example elements for streaming an extended video from a server to the display apparatus according to an example embodiment. As illustrated in FIG. 6, the extended video 21 is produced in an image producing device 51 by a content producer, and uploaded to the server 19 located at a side of a content provider. The image producing device 51 may include various types of image producing devices, such as, for example, and without limitation, a personal computer (PC), a smart phone, a tablet computer, or the like, and perform photographing and editing functions for a content image. The extended video 21 uploaded to the server 19 is provided to the display apparatus 10 in response to a user's play request in the display apparatus 10.

To produce the extended video 21, the image producing device 51 acquires a plurality of videos omni-directionally photographed by the content producer using a plurality of lenses (511). The image producing device 51 extracts frames of the respective photographed videos in the form of images (512). The image producing device 51 assigns weights to the respective extracted images according to specific areas and timeslots (513). At this time, the weights according to the specific areas and timeslots may be set by production purpose of the content producer, and such a set weight may be reflected in the resolutions for the plurality of segments when the server 19 streams the extended video 21.

After assigning the weights to the respective images, the image producing device 51 stitches the respective images together (514), and creates the extended video 21 by processing the stitched images in the form of a frame.

As described above, the extended video 21 produced by the image producing device 51 is uploaded to the server 19 located at the side of the content provider.

The server 19 receives and stores the plurality of extended videos 21 produced in the image producing device 51. The server 19 generates and stores images 52 corresponding to all possible combinations between the plurality of segments and the plurality of resolutions from the extended videos 21. According to an example embodiment, the server 19 divides the whole area of the extended video 21 into a plurality of segments corresponding to upper left, upper right, upper front, upper rear, lower left, lower right, lower front and lower rear areas, and stores a plurality of images different in resolution with respect to each segment. For example, images may be stored with resolutions of 1280*720(720p), 1920*1080(1080p) and 3840*2160(4K) for the segment corresponding to the upper left area among the plurality of segments divided from the extended video 21. Likewise, images may be stored with many resolutions for other segments.

The display apparatus 10 receives a user's play request for viewing the extended video 21. In response to a user's play request, the display apparatus 10 collects information about a current network state 531, information about a user's current line of sight sensed by, for example, an iris recognition sensor or a gyro sensor, information about a user's gesture and voice, or the like user information 532, and transmits the collected information to the server 19.

The server 19 determines the highest resolution for streaming the extended video 21, based on the information about the network state 531 received from the display apparatus 10.

The server 19 determines respective weights for the plurality of segments, based on at least one of the information about a user's current line of sight, the information about a user's gesture and voice, the information about movement of former users' line of sight according to timeslots, the weight information set when the extended video is produced, and the advertisement information, which are received from the display apparatus 10.

The server 19 determines a resolution for streaming the extended video 21 according to the plurality of segments, based on the weight information assigned to the plurality of segments determined as described above. For example, if it is determined that a high weight is assigned to the segment corresponding to the upper left area among the plurality of segments, an image processed to have the highest resolution of 3840*2160(4K) is streamed among the images respectively stored with the resolutions of 1280*720(720p), 1920*1080(1080p) and 3840*2160(4K). On the other hand, if it is determined that a low weight is assigned to the segment corresponding to the upper right area, an image processed to have the lowest resolution of 1280*720(720p) is streamed.

As described above, the server 19 streams images, which are respectively processed with different resolutions according to the plurality of segments of the extended video 21, to the display apparatus 10, thereby achieving adaptive streaming.

The display apparatus 10 stitches the images, which are different in resolution according to the plurality of segments received from the server 19 by the adaptive streaming, together into one frame, and reproduces the extended video 21 based on such a generated image frame (533).

While reproducing the extended video 21 (533), the display apparatus 10 may crop and display an area corresponding to an angle of view from the whole area of the extended video 21 based on the information about the angle of view corresponding to a user's line of sight.

Such an operation of stitching the images, which respectively correspond to the plurality of segments received from the server 19, together and cropping a part corresponding to a line of sight from the whole of the stitched image may be performed by a graphic processing unit (GPU) of the display apparatus 10.

The display apparatus 10 may continuously transmit information about a network state, a user's current line of sight, a user's gesture and voice, or the like, to the server 19 while reproducing the extended video 21 (533). The server 19 may adjust weight information according to the plurality of segments based on the information continuously provided from the display apparatus 10, and may change the resolutions according to the plurality of segments based on the adjusted information, thereby achieving the adaptive streaming.

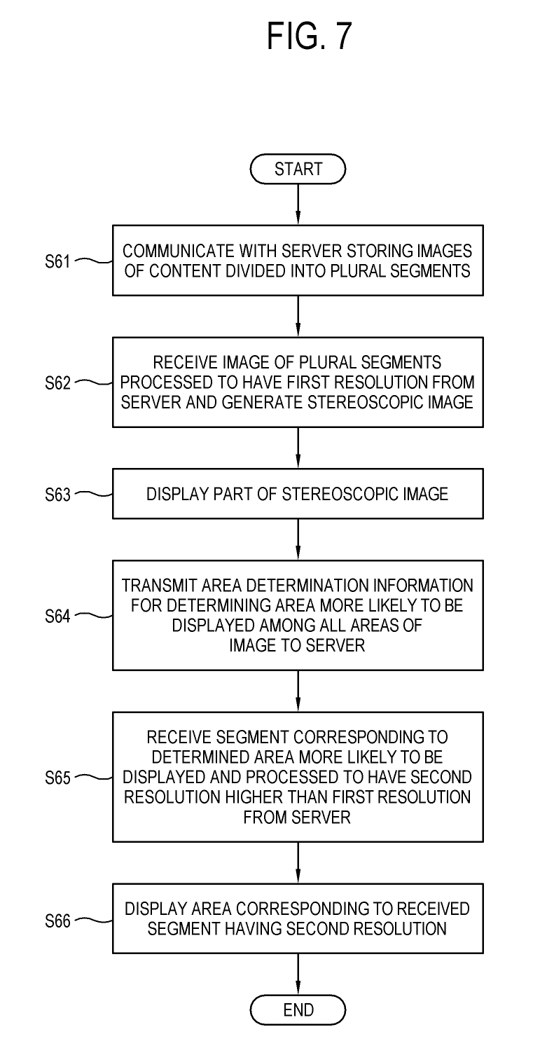

FIG. 7 is a flowchart illustrating an example method of controlling the display apparatus according to an example embodiment. As illustrated in FIG. 7, at operation S61, the display apparatus 10 communicates with the server 19 which stores images of contents divided according to the plurality of segments. Here, the images of content divided according to the plurality of segments may be processed according to the plurality of resolutions and stored in the server 19.

At operation S62, the display apparatus 10 receives the images corresponding to the plurality of segments processed to have the first resolution from the server 19 and generates a stereoscopic image 35. If the image of content stored in the server 19 is a 360-degree image taken and produced by the plurality of cameras, the stereoscopic image is created in the form of a sphere.

At operation S63, the display apparatus 10 displays an area of the stereoscopic image 35. The operation S63 may include displaying an area selected by a user from the whole area of the stereoscopic image 35 or displaying an area corresponding to an initial default reproducing position of the stereoscopic image 35.

At operation S64, the display apparatus 10 sends the server 19 information for determining an area more likely to be displayed within the whole areas of the stereoscopic image 35. Here, the information may include at least one of information about a user's current line of sight, information about movement of users' lines of sights according to timeslots, and information about a user's gesture and voice.

According to an example embodiment, the operation S64 may include an operation of periodically transmitting the information to the server 19. Thus, the latest information for predicting the movement in a user's line of sight is reflected in streaming a part of the extended video more likely to be displayed on a screen.

According to an example embodiment, the operation S64 may include an operation of transmitting information about a network state of the display apparatus 10 to the server 19, and an operation of determining the highest resolution of an image corresponding to at least one segment received from the server 19 based on the received information about the network state. Thus, it is possible to stream the extended video having the optimum resolution while taking the network state into account.

At operation S65, the display apparatus 10 receives at least one segment corresponding to an area more likely to be displayed, which is determined based on the information and processed to have a second resolution higher than the first resolution, from the server 19. The server 19 may determine the area more likely to be displayed on the display 13 within the whole areas of the stereoscopic image 35, based on at least one of information received from the display apparatus 10, content production information involved as appended information in the content image, and advertisement information.

According to an example embodiment, the operation S65 may further include an operation of receiving at least one segment, which does not correspond to the determined area more likely to be displayed and is processed to have a third resolution lower than the first resolution, from the server 19. Thus, a part of the extended video more likely to be displayed on the screen is processed to have a higher resolution than the other parts, and it is therefore possible to provide an image with higher quality even under a restricted network state.

According to an example embodiment, the operation S65 may further include an operation of preferentially receiving at least one first segment corresponding to the determined area more likely to be displayed from the server 19, and then receiving at least one second segment not corresponding to the area more likely to be displayed. Thus, a part of the extended video more likely to be displayed on the screen is preferentially streamed, and it is therefore possible to provide an image with higher quality even under a restricted network state.

According to an example embodiment, the operation S65 may further include an operation of making at least one first segment, which corresponds to the determined area more likely to be displayed and is received from the server 19, and at least one second segment, which does not correspond to the area more likely to be displayed, be stitched together. Thus, a plurality of segments received with different resolutions are stitched together and reproduced as one frame.

At operation S66, the display apparatus 10 displays an area corresponding to at least one received segment having the second resolution.

The foregoing method of controlling the display apparatus according to an example embodiment provides a vivid and realistic extended video to a user even under a restricted network when the user views the extended video.

As described above, according to an example embodiment, it is possible to continuously provide a high-quality extended video to a user when the user views the extended video.

Further, according to an example embodiment, it is possible to provide a vivid and realistic extended video to a user even under a restricted network when the user views the extended video.

Although various example embodiments have been illustrated and described, it will be appreciated by those skilled in the art that changes may be made in these example embodiments without departing from the principles and spirit of the disclosure, the scope of which is defined in the appended claims and their equivalents.

What is claimed is:

1. A display apparatus comprising:
a communicator comprising communication circuitry configured to communicate with a server capable of providing content divided into segments and having a plurality of resolutions;
a video processor configured to perform a video process on the content;
a display configured to display an image of the processed content; and
a controller configured to control the display apparatus to receive a segment of the content having a first resolution from the server, to display an area of a stereoscopic image on the display based on the received segment, to transmit information about an area more likely to be displayed within the stereoscopic image to the server, to receive a segment corresponding to the area more likely to be displayed and having a second resolution higher than the first resolution from the server, and to display the stereoscopic image based on the received segment having the second resolution.

2. The display apparatus according to claim 1, wherein the information comprises at least one of: information about a current line of sight, information about movement in sight lines according to timeslots, and information about a gesture and a voice.

3. The display apparatus according to claim 2, wherein the server is configured to determine an area more likely to be displayed within the stereoscopic image based on at least one of: information received from the display apparatus, content production information involved in the content, and advertisement information.

4. The display apparatus according to claim 1, wherein the controller is configured to control the display apparatus to transmit information about a network state of the display apparatus to the server, and to determine a highest resolution of an image of a segment received from the server based on the network state.

5. The display apparatus according to claim 1, wherein the controller is configured to receive a segment, which does not correspond to the area more likely to be displayed and having a third resolution lower than the first resolution, from the server.

6. The display apparatus according to claim 1, wherein the controller is configured to control the video processor to stitch together a first segment corresponding to the area more likely to be displayed and a second segment not corresponding to the area more likely to be displayed, which are received from the server.

7. The display apparatus according to claim 1, wherein the controller is configured to control the display to receive a first segment corresponding to the area more likely to be displayed, and to then receive a second segment not corresponding to the area more likely to be displayed, from the server.

8. The display apparatus according to claim 1, wherein the controller is configured to control the display apparatus to periodically transmit information about the area more likely to be displayed to the server.

9. The display apparatus according to claim 2, wherein the controller is configured to control the display apparatus to transmit information about the current line of sight to the server if the current line of sight is maintained for a predetermined period of time or more.

10. The display apparatus according to claim 1, wherein the server is configured to store the segments divided from the content and processed according to a plurality of resolutions.

11. A method of controlling a display apparatus, the method comprising:
communicating with a server capable of providing content divided into segments and having a plurality of resolutions;
receiving a segment of the content having a first resolution from the server, and displaying an area of a stereoscopic image on the display based on the received segment;
transmitting information about an area more likely to be displayed within the stereoscopic image to the server;
receiving a segment corresponding to the area more likely to be displayed and having a second resolution higher than the first resolution from the server; and
displaying the stereoscopic image based on the received segment having the second resolution.

12. The method according to claim 11, wherein the information comprises at least one of: information about a current line of sight, information about movement in sight lines according to timeslots, and information about a gesture and a voice.

13. The method according to claim 12, wherein the server determines an area more likely to be displayed within the stereoscopic image based on at least one of: information received from the display apparatus, content production information involved in the content, and advertisement information.

14. The method according to claim 11, further comprising:
transmitting information about a network state of the display apparatus to the server; and
determining a highest resolution of an image of a segment received from the server based on the network state.

15. The method according to claim 11, further comprising:
receiving a segment, which does not correspond to the area more likely to be displayed and having a third resolution lower than the first resolution, from the server.

16. The method according to claim 11, further comprising:
stitching together a first segment corresponding to the area more likely to be displayed and a second segment not corresponding to the area more likely to be displayed, which are received from the server.

17. The method according to claim 11, further comprising:
receiving a first segment corresponding to the area more likely to be displayed from the server; and
then receiving a second segment not corresponding to the area more likely to be displayed from the server.

18. The method according to claim 11, further comprising:
periodically transmitting information about the area more likely to be displayed to the server.

19. The method according to claim 12, further comprising:
transmitting information about the current line of sight to the server if the current line of sight is maintained for a predetermined period of time or more.

20. A computer program product comprising instructions stored in a memory which, when executed by a processor, cause a display device to perform operations comprising:
controlling the display apparatus to receive a segment of the content having a first resolution from a server,
displaying an area of a stereoscopic image on a display based on the received segment,
transmitting information about an area more likely to be displayed within the stereoscopic image to the server,
receiving a segment corresponding to the area more likely to be displayed and having a second resolution higher than the first resolution from the server, and
displaying the stereoscopic image based on the received segment having the second resolution.
